(19) United States
(12) Patent Application Publication
(10) Pub. No.: US 2025/0369244 A1
(43) Pub. Date: Dec. 4, 2025

(54) HOT TUB AND COMPONENTS THEREOF

(71) Applicant: Bret Yerkovich, Palo Alto, CA (US)

(72) Inventor: Bret Yerkovich, Palo Alto, CA (US)

(21) Appl. No.: 19/222,286

(22) Filed: May 29, 2025

Related U.S. Application Data
(60) Provisional application No. 63/655,379, filed on Jun. 3, 2024.
(60) Provisional application No. 63/682,879, filed on Aug. 14, 2024.
(60) Provisional application No. 63/719,755, filed on Nov. 13, 2024.

(51) Int. Cl. E04H 4/12; A61H 33/00; E04H 4/00; E04H 4/08; H02J 7/00

(52) U.S. Cl. CPC E04H 4/129; A61H 33/005; A61H 33/0095; A61H 33/6089; H02J 7/0063; A61H 2201/0207; A61H 2201/0228; A61H 2201/1207; E04H 4/0037; E04H 4/08; H02J 2207/20

(57) ABSTRACT

A hot tub hybrid power system includes a connector and at least one battery. The connector is configured to receive AC power from an external source at a first power level. The at least one battery is in combination with a DC to AC power transformer configured to output AC voltage at a second power level. A combiner/regulator is configured to selectively output power at the first level, the second level, or a combination of the first and second level based on a state of a hot tub.

### RELATED APPLICATIONS

This application claims the benefit of U.S. Provisional Application No. 63/655,379, filed Jun. 3, 2024, U.S. Provisional Application No. 63/682,879, filed Aug. 14, 2024, and U.S. Provisional Application No. 63/719,755, filed Nov. 13, 2024, the contents which are incorporated herein by reference in their entireties.

### FIELD OF INTEREST

The present inventive concepts relate to hot tubs and components thereof, such as covers or lids and power sources.

### BACKGROUND

Outdoor hot tubs, sometimes referred to as spas, use electric energy to heat water up to 104 degrees F. and maintain it at that level constantly, or at whatever desired water temperature is set by the user. Heat loss occurs across the entire hot tub body, but the lid is the focal point of most heat loss, as heat rises. Hot tub covers or lids are removable and made out of vinyl and filled with foam insulation that is 2-4 inches thick, providing an R value of 15-20. “R value” is a measure of how well a two-dimensional barrier, such as a layer of insulation, e.g., a window or a complete wall or ceiling, resists the conductive flow of heat.

It would be advantageous to have a hot tub lid with better insulating properties to limit heat loss and save energy. It would be advantageous to have a hot tub basin or body with better insulating properties to limit heat loss from the sides and bottom of the hot tub and save energy. It would be further advantageous to have a hot tub with a hybrid power system that includes a battery source and that can operate off of standard household power.

### SUMMARY

In one aspect, a hot tub lid comprises at least one panel that includes at least one multi-wall, vacuum insulated structure.

In one embodiment, a hot tub lid comprises at least one panel that includes at least one multi-wall, vacuum insulated structure.

In one embodiment, the at least one panel has a first end configured to couple to a first end of a hot tub.

In one embodiment, the lid is configured for installation onto existing hot tub units.

In one embodiment, the hot tub lid comprises an R value of the lid is at least about 40.

In one embodiment, the at least one multi-wall vacuum-insulated structure comprises at least two walls having a vacuum insulated volume therebetween.

In one embodiment, the at least one multi-wall vacuum-insulated structure comprises at least two sheet metal walls with a vacuum insulating fill therebetween.

In one embodiment, the at least one multi-wall vacuum-insulated structure comprises anodized aluminum.

In one embodiment, the at least one multi-wall vacuum-insulated structure comprises an anti-corrosion material, layer, plating, and/or coating.

In one embodiment, the at least one multi-wall vacuum-insulated structure comprises carbon fiber.

In another aspect, the hot tub comprises a water holding shell having at least one portion that includes at least one multi-wall vacuum-insulated structure.

In one embodiment, the R value of the shell is at least about 40.

In one embodiment, the at least one multi-wall vacuum-insulated shell comprises at least two walls having a vacuum insulated volume therebetween.

In one embodiment, the hot tub further comprises a cabinet housing having a plurality of walls that enclose the shell.

In one embodiment, the plurality of walls of the cabinet includes at least one wall having a multiwall vacuum-insulated structure.

In one embodiment, the plurality of walls of the cabinet includes at least four walls having a multiwall vacuum-insulated structure.

In one embodiment, the cabinet includes a bottom having a multiwall vacuum-insulated structure.

In one embodiment, the R value of the multiwall vacuum-insulated structure is at least about 40.

In one embodiment, the at least one multi-wall vacuum-insulated structure comprises anodized aluminum.

In one embodiment, the at least one multi-wall vacuum-insulated structure comprises carbon fiber.

In one embodiment, the at least one multi-wall vacuum-insulated structure comprises an anti-corrosion material, layer, plating, and/or coating.

In another aspect, a hot tub comprises a cabinet housing having a plurality of walls that enclose a shell, including at least one wall having a multiwall vacuum-insulated structure.

In one embodiment an R value of the cabinet is at least about 40.

In one embodiment, the plurality of walls of the cabinet includes at least four walls having a multiwall vacuum-insulated structure.

In one embodiment, the cabinet includes a bottom having a multiwall vacuum-insulated structure.

In one embodiment, the at least one multi-wall vacuum-insulated structure comprises anodized aluminum.

In one embodiment, the at least one multi-wall vacuum-insulated structure comprises carbon fiber.

In one embodiment, the at least one multi-wall vacuum-insulated structure comprises anti-corrosion material, layer, coating, or plating.

In another aspect, a hot tub hybrid power system comprises a connector and at least one battery. The connector is configured to receive AC power from an external source at a first power level. The at least one battery is in combination with a DC to AC power transformer configured to output AC voltage at a second power level. A combiner/regulator is configured to selectively output power at the first level, the second level, or a combination of the first and second level based on a state of a hot tub.

In one embodiment, the first level and the second power level are substantially the same.

In one embodiment, the first power level is 120 VAC.

In one embodiment, the first power level is 240 VAC.

In one embodiment, the combiner/regulator is configured to synchronize a phase of the AC power from the external source with a phase of AC power from the DC to AC power transformer.

In one embodiment the combiner/regulator is configured to determine the power level of the external source and adjust the second power level based on the first power level.

In one embodiment, the external source provides 120 VAC, the combiner/regulator draws 120 VAC from the at least one battery and DC to AC transformer to deliver 240 VAC during a hot tub full operation or use state.

In one embodiment, the at least one battery is configured to charge to full capacity when the hot tub is an idle or nonuse state.

In one embodiment, the battery has a storage capacity between about 1 kWh and about 100 kWh.

In one embodiment, the storage capacity is between about 10 kWh and about 15 kWh.

In one embodiment, the combiner/regulator facilitates continuous full power supply to all hot tub systems and subsystems from the external source and the battery DC to AC transformer during use or full operation.

In one embodiment, the combiner/regulator is configured to selectively prioritize drawing power from the battery during peak utility pricing periods.

In one embodiment, the system is modularly configured externally to the hot tub for powering pre-existing hot tubs.

In one embodiment, the system further comprises a heater that includes a heat pump, a gas heater, a propane heater, or an electric heater powered by a 120V or 240V electrical source.

In one embodiment the hybrid power system is external to a hot tub.

In one embodiment, the combiner is configured to be coupled with the power cord of the hot tub.

In one embodiment, the system further comprising a control system configured to monitor the state of the hot tub and regulate power output from the external source and the battery based on operational conditions.

In one embodiment, the control system is configured to prioritize battery power during high energy demand conditions to enable simultaneous operation of a water heater and hydrotherapy jets.

In one embodiment, the hot tub comprises a body having a shell with a multiwall vacuum-insulated structure, and wherein the combiner/regulator is configured to maintain a set water temperature within the shell during periods of low external power availability by prioritizing battery output.

In one embodiment, the hot tub comprises a lid having at least one panel configured for installation onto existing hot tub units, the panel including a multi-wall vacuum-insulated structure formed of at least two anodized aluminum sheet metal walls with a vacuum-insulated volume therebetween, the structure further comprising an anti-corrosion layer.

In another aspect, a system for heating hot tub water comprises an induction coil, a hot tub shell, and a control system. The induction coil is configured to generate a magnetic field in response to an alternating current. The hot tub shell comprises a conducting material and is configured to heat water by eddy currents from the magnetic field. The control system is configured to monitor an alternating current supplied to the induction coil that controls the temperature of the water.

In one embodiment, the system further comprises a user interface on the control system to allow for temperature adjustment by a user.

In one embodiment, the induction coil is positioned adjacent to the hot tub shell.

In one embodiment, the induction coil is positioned between an outer wall of the hot tub shell and a panel of a cabinet.

In one embodiment, the induction coil is positioned at a base of the hot tub shell between an outer wall of the hot tub shell and a bottom panel of the cabinet.

In one embodiment, the hot tub shell comprises a ferromagnetic material.

In one embodiment, the system further comprises a pump configured to circulate water.

In one embodiment, the system further comprises a temperature sensor configured to monitor water temperature and provide feedback to the control system.

In one embodiment, the control system receives feedback from the temperature sensor to adjust frequency and power of the alternating current based on a desired water temperature.

In one embodiment, the system further comprises an alternative heating element used with the induction coil for heating hot tub water.

In one embodiment, the control system is configured to selectively turn on the alternative heating element and the induction coil.

In another aspect, a hot tub system comprises a lid, a hot tub body, a hybrid power system, and an induction heating system.

In one aspect, a hot tub hybrid power system comprises a connector, at least one battery, and a combiner/regulator. The connector is configured to receive AC power from an external source at a first power level. The at least one battery works in in combination with a DC to AC power transformer configured to output AC voltage at a second power level. The combiner/regulator is configured to selectively output power at the first level, the second level, or a combination of the first and second level based on a state of a hot tub.

In one embodiment, the first level and the second power level are substantially the same.

In one embodiment, the first power level is 120 VAC.

In one embodiment, the first power level is 240 VAC.

In one embodiment, the combiner/regulator is configured to synchronize a phase of the AC power from the external source with a phase of AC power from the DC to AC power transformer.

In one embodiment, the combiner/regulator is configured to determine the power level of the external source and adjust the second power level based on the first power level.

In one embodiment, when the external source provides 120 VAC, the combiner/regulator draws 120 VAC from the at least one battery and DC to AC transformer to deliver 240 VAC during a hot tub full operation or use state.

In one embodiment, the at least one battery is configured to charge to full capacity when the hot tub is an idle or nonuse state.

In one embodiment, the battery has a storage capacity between 1 kWh and 100 kWh.

In one embodiment, the storage capacity of the battery is between 10 kWh and 15 kWh.

In one embodiment, the combiner/regulator is configured to supply continuous full power supply to a water heater and hydrotherapy jets during simultaneous operation from the external source and a battery DC to AC transformer during use or full operation.

In one embodiment, the combiner/regulator is configured to selectively prioritize drawing power from the battery during peak utility pricing periods.

In one embodiment, the system is modularly configured external to the hot tub for powering pre-existing hot tubs.

In one embodiment, the system further comprises a heater that includes a heat pump, a gas heater, a propane heater, or an electric heater powered by a 120V or 240V electrical source.

In one embodiment, the hybrid power system is external to a hot tub.

In one embodiment, the combiner is configured to couple with a power cord of the hot tub.

In one embodiment, the system further comprises a control system configured to monitor the state of the hot tub and regulate power output from the external source and the battery based on operational conditions.

In one embodiment, the control system is configured to prioritize battery power during high energy demand conditions to enable simultaneous operation of a water heater and hydrotherapy jets.

In one embodiment, the hot tub comprises a body having a shell with a multiwall vacuum-insulated structure, and wherein the combiner/regulator is configured to maintain a set water temperature within the shell during periods of low external power availability by prioritizing battery output.

In one embodiment, the hot tub comprises a lid having at least one panel configured for installation onto existing hot tub units, the panel including a multi-wall vacuum-insulated structure formed of at least two anodized aluminum sheet metal walls with a vacuum-insulated volume therebetween, the structure further comprising an anti-corrosion layer.

### BRIEF DESCRIPTION OF THE DRAWINGS

Aspects of the present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an embodiment of a hot tub lid, in accordance with aspects of inventive concepts.

FIG. 2 includes a top view and a side view of the hot tub lid of FIG. 1, in accordance with aspects of inventive concepts.

FIG. 3 includes a bottom view and a side view of the hot tub lid of FIG. 1, in accordance with aspects of inventive concepts.

FIGS. 4A-B provide a side view of a joint of the hot tub lid of FIG. 1, in accordance with aspects of inventive concepts.

FIG. 5 is a perspective, disassembled view of the hot tub lid of FIG. 1, in accordance with aspects of inventive concepts.

FIG. 6 is a perspective view of the hot tub lid of FIG. 1 installed on a hot tub, in accordance with aspects of inventive concepts.

FIG. 7A is a cross-sectional side view of the hot tub lid and hot tub of FIG. 6, in accordance with aspects of inventive concepts.

FIG. 7B is a cross-sectional front view of the hot tub lid and hot tub of FIG. 6, in accordance with aspects of inventive concepts.

FIG. 8 is a circuit diagram of an embodiment of a hot tub hybrid power system, in accordance with aspects of inventive concepts.

FIG. 9 is a circuit diagram of another embodiment of a hot tub hybrid power system, in accordance with aspects of inventive concepts.

FIG. 10 is a cross-sectional front view of the hot tub lid and hot tub of FIG. 6, in accordance with aspects of inventive concepts.

### DETAILED DESCRIPTION OF EXEMPLARY EMBODIMENTS

Various aspects of the inventive concepts will be described more fully hereinafter with reference to the accompanying drawings, in which some exemplary embodiments are shown. Aspects of the present inventive concepts may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing.

### Hot Tub Lid

In accordance with the inventive concepts, provided is a hot tub lid having a multiwall vacuum-insulated structure, including a vacuum insulation pocket between at least two of the multilayers. As an example, the lid can be made of or include a double wall vacuum insulated structure that allows for superior R value of around 40-60, a 200-300% increase over existing foam insulation solutions used in hot tub lids. In some embodiments, lid can be configured for installation on existing hot tub units. In some embodiments, the lid is designed to retrofit or replace existing hot tub lids on already installed hot tub units.

In some embodiments, the multiwall vacuum insulated structure can include at least two layers of carbon fiber material with a vacuum insulated pocket therebetween. In some embodiments, the multiwall vacuum insulated structure can include at least two layers of sheet metal with a vacuum insulated pocket therebetween. In some embodiments, the at least two layers of sheet metal can comprise or be made of aluminum, titanium, and/or steel. In some embodiments, the aluminum, titanium, and/or steel layers incorporate anodization and/or anticorrosion coatings. In some embodiments, the aluminum and/or steel layers incorporate nickel plating or electroless nickel plating for corrosion resistance. In some embodiments, the multiwall vacuum insulated structure can include at least two layers of non-metal sheets with a vacuum insulated pocket or fill therebetween.

In some embodiments, the multiwall vacuum insulated structure and/or at least two layers thereof are covered with an electrically insulating material, layer, or coating. In some embodiments, the multiwall vacuum insulated structure and/or at least two layers thereof are covered with a thermally insulating material, layer, or coating. In some embodiments, the multiwall vacuum insulated structure and/or at least two layers are covered with an electrically insulating material, layer, or coating and a thermally insulating material, layer, or coating. In some embodiments, the electrically insulating material and/or thermally insulating material serve as an anti-corrosion coating that comprises one or more of mica, Teflon, rubber, plastic, polyvinyl chloride (PVC), Chemical Plasma Vapor Deposition (CPVD) coating, vitreous enamel, fiberglass, silicone. In some embodiments, the electrically and/or thermally insulating material could be applied to encase the multiwall vacuum insulated structure with a shrink-wrapped film or multilayer film.

In other embodiments, another solution for achieving vacuum insulation is to insert vacuum insulated panels into a structure of the lid. For example, in some embodiments, the lid can comprise a padded vinyl envelope within which at least one multiwall vacuum insulated structure can be disposed to improve the R value of the lid. In some embodiments, this could be accomplished using one or more pre-made vacuum insulated panels that are then adapted for use as part of a hot tub lid as described. Such adaptations could include size adaptations and/or adding coatings, films, or layers of an electrically insulating and/or thermally insulating material to the multiwall vacuum insulated panels.

Interior insulation and structural support used to create a multiwall vacuum insulated sheet can include vacuum filled with inert gas, fumed silica, silica powder, and/or aerogels, or nothing at all and using the rigidity of the exterior for support, as examples.

In various embodiments, a sheet used for forming a multiwall vacuum insulated structure of the lid can be made of or comprise one or more of the following: stainless steel, aluminum, titanium, copper, sheet metal, carbon fiber, acrylic, plastics, wood, stone, porcelain, fiberglass, plexiglass, and/or glass, as examples. In various embodiments, when the sheet comprises or is made of a corrosive material, an anticorrosive material, layer, plating, and/or coating can be applied to at least a side of the sheet that is contacted by water, regardless of its form. In some embodiments, the sheet can comprise one or more of the following: titanium stainless steel, aluminum with anodization, a clearcoat or other plastic based sealer, Chemical Plasma Vapor Deposition (CPVD), vitreous email, nickel plating, electroless nickel plating, or porcelain enamel. In some embodiments, the sheet can comprise a thin (light) stainless steel reinforced with fiberglass or some other layer. In various embodiments, the stainless steel could have a thickness in a range of about 10 to 20 gauge. In various embodiments, the stainless steel could have a thickness in a range of about 14 to 16 gauge.

In various embodiments, a method for creating a vacuum between layers can include any now known or hereafter developed method, including, but not limited to using a vacuum chamber and/or a gas release valve.

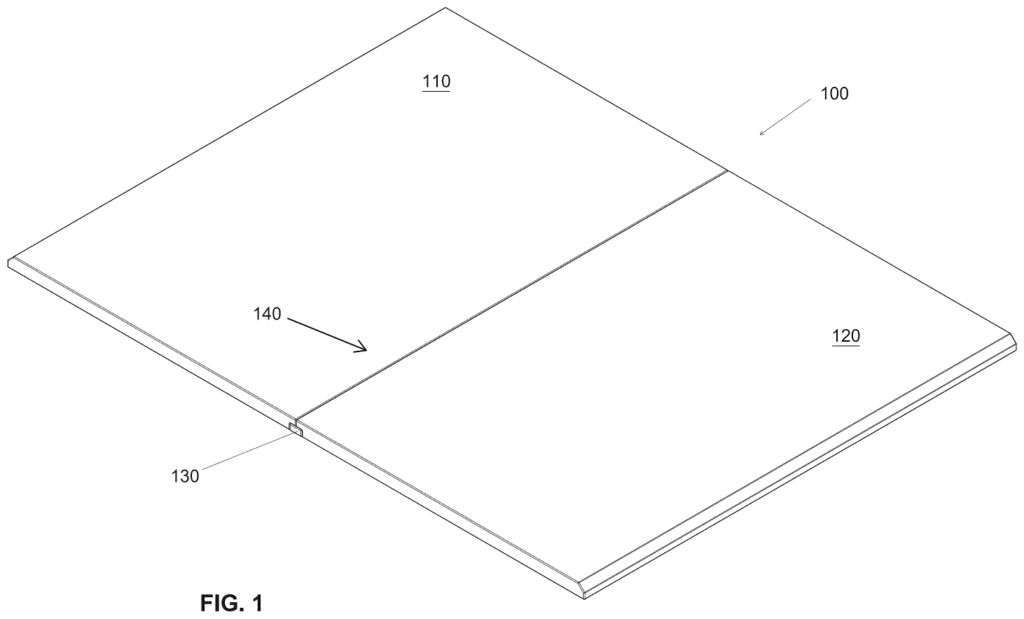

FIG. 1 is a perspective view of an embodiment of a hot tub lid 100, in accordance with aspects of inventive concepts, where a first panel 110 of the hot tub lid 100 is joined or coupled to a second panel 120 of the hot tub lid 100 at a joint member 130 of the hot tub lid 100. The first panel 110 and the second panel 120 are configured to rotate with respect to each other at a hinge 140 that includes the joint member 130.

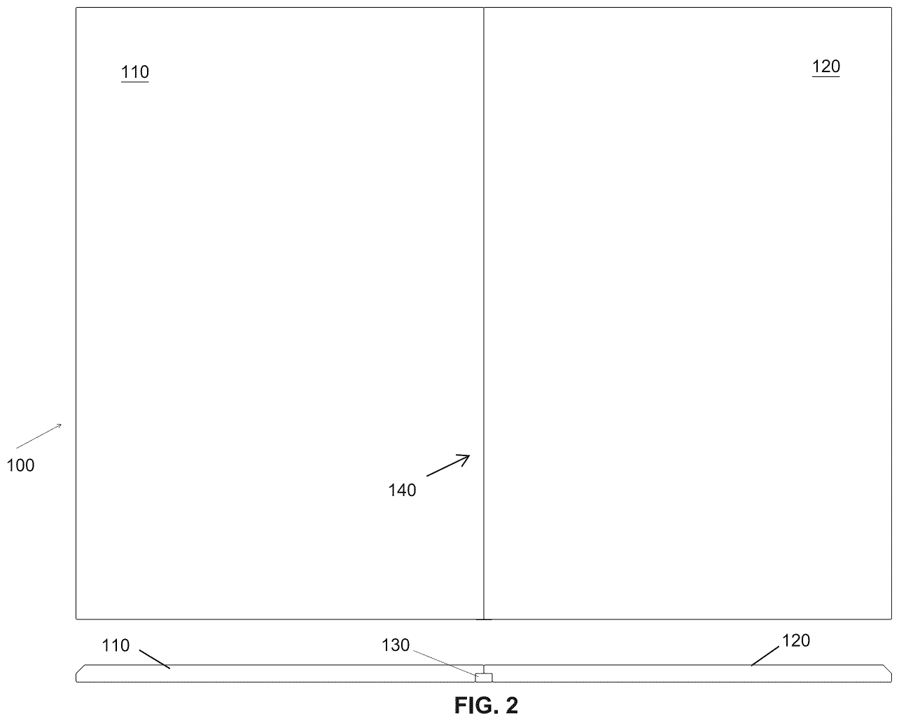

FIG. 2 includes a top view and a side view of the hot tub lid 100 of FIG. 1, in accordance with aspects of inventive concepts, where the first panel 110 of the hot tub lid 100 is joined or coupled to the second panel 120 of the hot tub lid 100 at the joint member 130 of the hot tub lid 100.

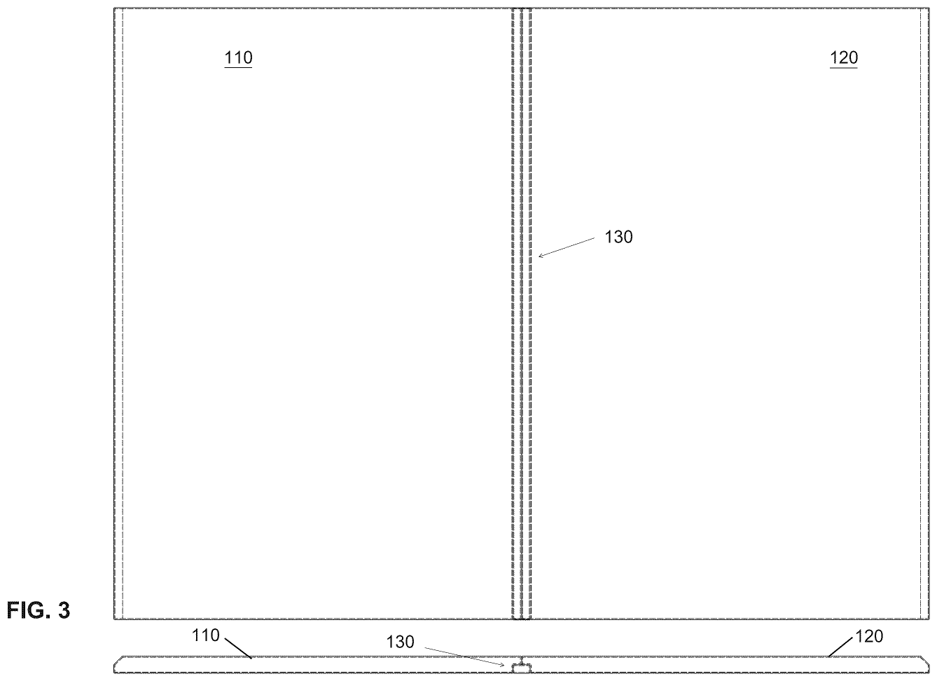

FIG. 3 includes a bottom view and a side view of the hot tub lid 100 of FIG. 1, in accordance with aspects of inventive concepts, where the first panel 110 of the hot tub lid 100 is joined or coupled to the second panel 120 of the hot tub lid 100 at the hinge 140 and joint member 130 of the hot tub lid 100. In the view of FIGS. 1-3, the first and second panels 110, 120 are shown as rectangular. In other embodiments, the size and shape of the cover and the panels of a hot tub lid are determined based on the dimensions of the hot tub the lid is to cover. There are no inherent limitations on the dimensions of the cover and panels for purposes of the inventive concepts.

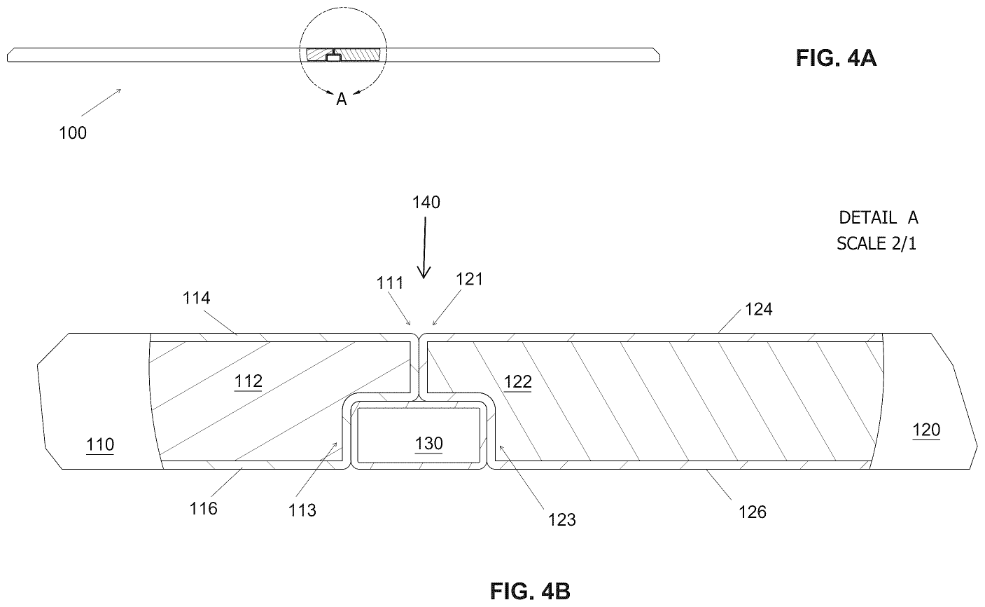

FIGS. 4A-B provide a cutaway, side view of a joint and portion of the first and second panels of the hot tub lid 100 of FIG. 1, in accordance with aspects of inventive concepts. In this view, the lid 100 includes a double wall structure, where the gap defined between the walls is vacuum filled. Each wall can comprise a sheet material, such as aluminum, as one example. The sheet material, e.g., aluminum, titanium, or stainless steel, can be coated and/or plated with an anticorrosive material, in some embodiments.

In this view, the first and second panels have substantially the same structure. The first panel includes a first panel top sheet 114 and a first panel bottom sheet 116 that form a void or gap that is filled with a first panel vacuum fill 112. The first panel 110 can have a first panel joint recession 113 and a first panel joint edge 111 formed to accommodate the joint member 130 and collectively form a rotatable joint 140 with the second panel 120. Similarly, the second panel 120 includes a second panel top sheet 124, a second panel bottom sheet 126, and is filled with the second panel vacuum fill 122. The second panel 120 has a second panel joint recession 123 and second panel joint edge 121 to accommodate the joint member 130 and join with the first panel 110.

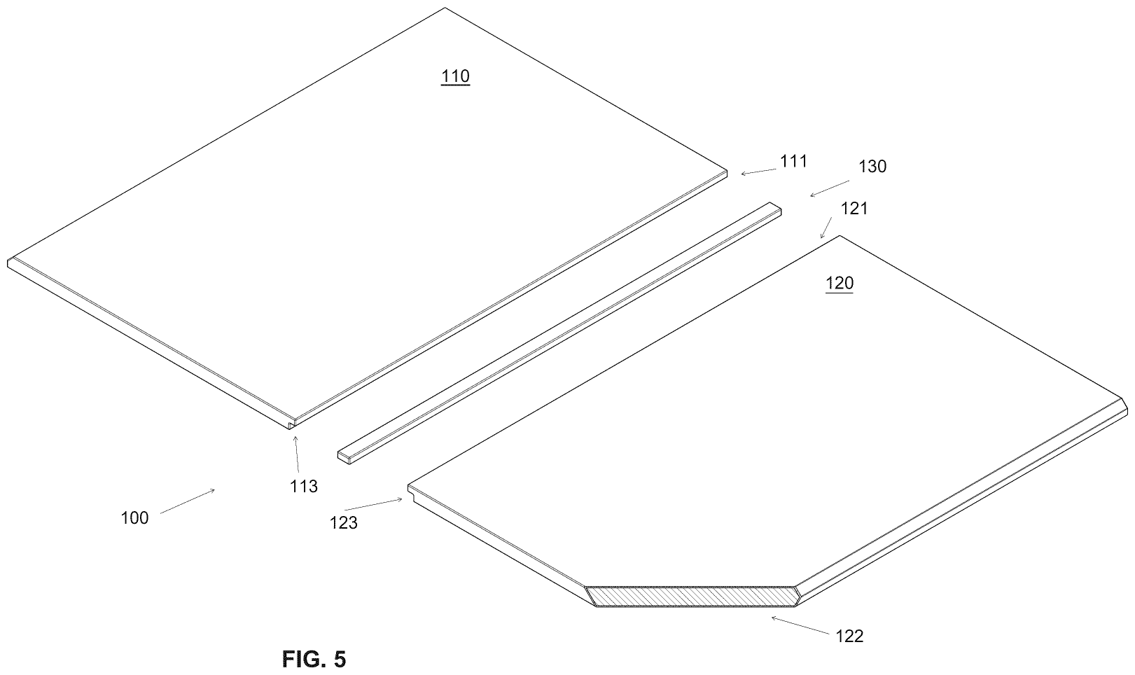

FIG. 5 is a perspective, disassembled view of the hot tub lid 100 of FIG. 1, in accordance with aspects of inventive concepts. This view depicts how the first panel 110 and the second panel 120 and the joint member 130 join together. The joint member 130 fits into the first panel joint recession 113 and second panel joint recession 123. The first panel 110 and second panel 120 mate at the first panel joint edge 111 and the second panel joint edge 121. A cross section of the second panel 120 depicts the hollow space within the panel occupied by the second panel vacuum fill 122.

As mentioned above, a hot tub lid in accordance with the inventive concepts can be configured to replace existing covers on already installed hot tubs, as a retrofit. In other embodiments, the hot tub lid could be newly installed with installation of a new hot tub. In either case, the hot tub lid could be part of a hot tub kit made to fit an already installed and/or newly installed hot tub.

### Hot Tub Body

The above inventive concepts can also be applied to the shell and/or the cabinet of the hot tub. For example, the walls of a hot tub cabinet can be made of or comprise one or more of the following: stainless steel, aluminum, titanium, copper, sheet metal, carbon fiber, acrylic, plastics, wood, stone, porcelain, fiberglass, plexiglass, and/or glass, as examples. For example, the walls of the hot tub cabinet can each comprise a multiwall vacuum-insulated structure and the shell of the hot tub, which holds the water, could include a multiwall vacuum-insulated structure. In various embodiments, the cabinet can include an anticorrosive material, layer, plating, and/or coating. Additionally, or alternatively, in various embodiments the hot tub shell can include an anticorrosive material, layer, plating, and/or coating.

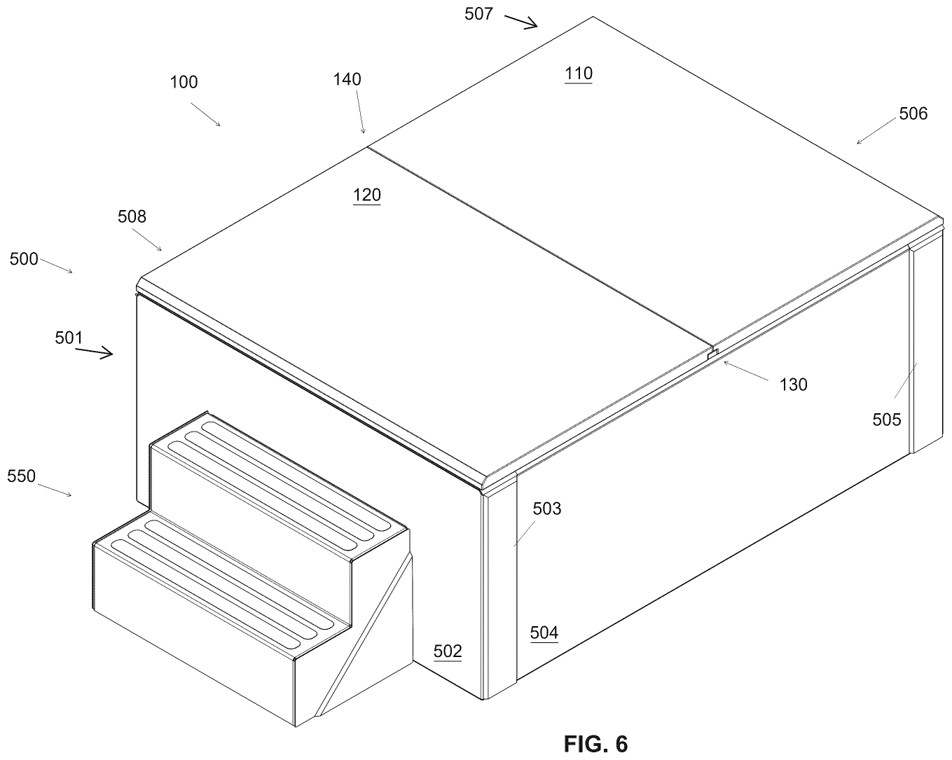

FIG. 6 is a perspective view of multiwall vacuum-insulated hot tub lid, such as lid 100 of FIG. 1, installed on a hot tub 500, in accordance with aspects of inventive concepts. In other embodiments, the hot tub could use a standard hot tub lid, without a multiwall vacuum-insulated structure.

This view depicts the hot tub lid 100 on top of and covering the top surfaces of the hot tub 500. A hot tub cabinet comprises a front wall 502, a right wall 504, a rear wall 506, and a left wall 508, which enclose a hot tub shell that is formed and contoured to accommodate seating and use of the hot tub when the shell is filled with water. The cabinet can also include end caps 501, 503, 505, 507.

In various embodiments, the walls of the cabinet can also have a multiwall, vacuum-insulated structure, like that of the first panel 110 and second panel 120 of the lid. But in other embodiments, the cabinet can be a standard cabinet with customary insulating materials and properties.

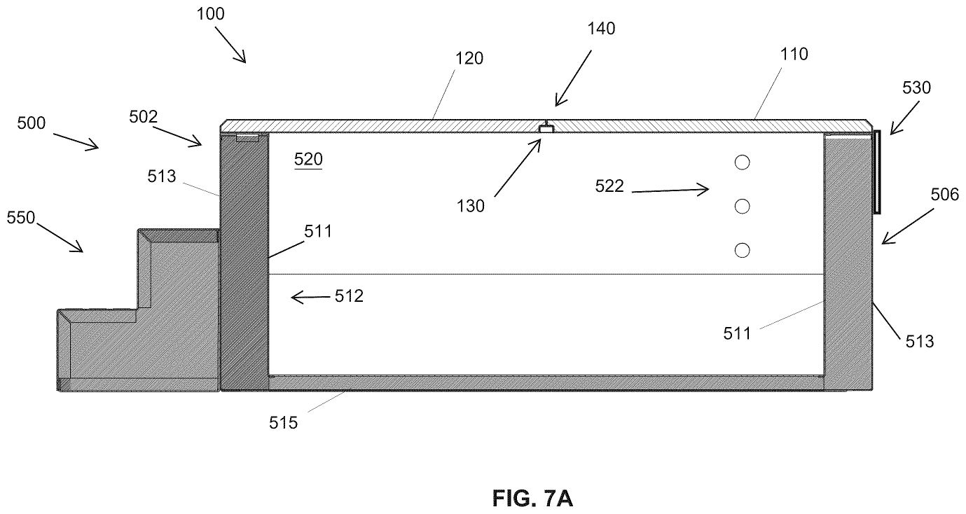

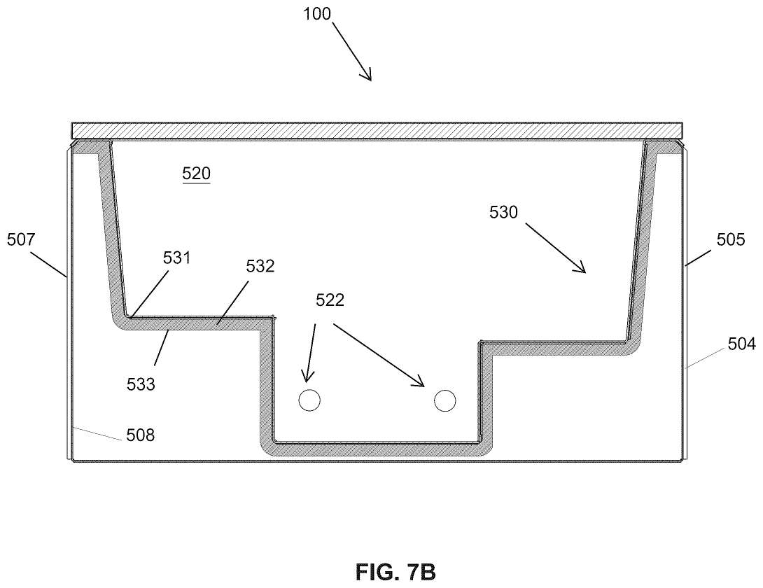

FIG. 7A is a cross-sectional side view of the hot tub lid 100 mounted to an embodiment of the hot tub 500, in accordance with aspects of inventive concepts. The hot tub lid 100 is installed on a hot tub 500 and connected using a cover support 530. The hot tub lid 100 can be opened and closed by rotating the first panel 110 about hinge 140, which includes joint member 130, relative to the second panel 120 and then rotating the second panel relative to the hot tub 500 using the cover support 530, which can include a lid hinge.

In this example, each of cabinet walls 502, 504, 506, 508 includes a multiwall vacuum-insulated structure, including an outer wall 513 (with atmosphere on the other side) and an inner wall 511 (with water on the inside and the body of the hot tub on the other side), with at least one vacuum insulating layer or material 512 in between. Collectively, walls 511 and 513 with vacuum insulating layer 512 therebetween form an embodiment of a multiwall vacuum-insulated structure in accordance with aspects of the inventive concepts. The cabinet can also include a bottom panel 515 that includes a multiwall vacuum-insulated panel, which may form an enclosure for the shall in combination with the cabinet walls 502, 504, 506, 508.

The hot tub shell may incorporate interior features 522, such as water jets, lights, filters, speakers, or other chosen features. The interior volume 520 of the hot tub 500 shell is configured to receive and hold water.

FIG. 7B is a cross-sectional front view of the hot tub lid 100 combined with an embodiment of the hot tub 500, in accordance with aspects of inventive concepts. This view shows the hot tub shell 530 comprising a multiwall vacuum-insulated structure, which includes an inner wall 531, an outer wall 533, and a vacuum insulated layer or material 532 therebetween. Collectively, walls 531 and 533 with vacuum insulating layer 532 therebetween form an embodiment of a multiwall vacuum-insulated structure in accordance with aspects of the inventive concepts.

In various embodiments, the shell can be made of fiberglass and lined with a multiwall vacuum insulated structure, e.g., panels. In other embodiments, the multiwall vacuum insulated structure could form the interior surface, including seating surfaces, of the shell. For example, in such a case, the multiwall vacuum insulated structure could comprise an interior wall 531 made of or including aluminum, stainless steel, or sheet metal. In various embodiments, the shell can include an anticorrosive material, layer, plating, and/or coating.

In various embodiments, the hot tub includes at least one heater which can be or include a heat pump in lieu of or in addition to a 120V or 240V AC powered electric resistance heater. In other embodiments, the hot tub heater can be or include a gas or propane heater in lieu of or in addition to a 120V or 240V AC powered electric resistance heater. In various embodiments, the hot tub can be heated using a standard electric resistance heater, an induction heater, or a combination that includes the two.

### Hybrid Power System

Currently, 99% of outdoors hot tubs in the USA run on a 240V power at 50 amps, which provides enough capacity to run a standard electric resistance water heater, pumps for circulation and hydro massage jet therapy, and other ancillary equipment like lights, speakers, and control panels. These 240V circuits draw a lot of power, typically at peak electric times like evenings, which is expensive, and most homes require an electrician to install the higher voltage line to the hot tub location. Some “plug and play” hot tub variants run on a standard outlet at 120V, but are not large in size (gallons of water), and have inferior heating and jets, making them less useful and totally infeasible for colder climates. Both 240V and 120V hot tubs today are unable to simultaneously heat the hot tub water while also running massage therapy jets due to electric current limitations which can cause the hot tub water to become cold during times of use.

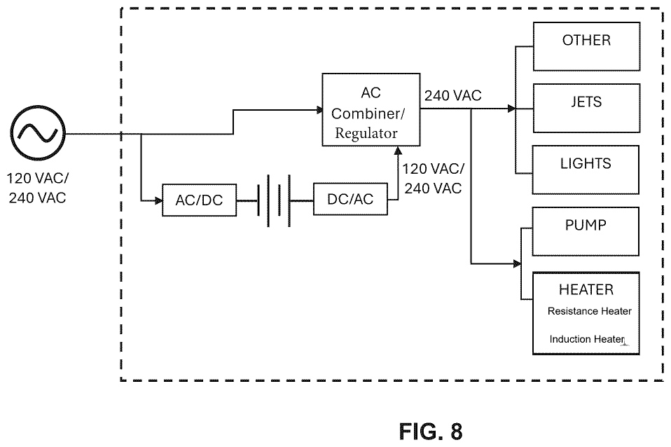

FIG. 8 is a circuit diagram of an embodiment of a hot tub hybrid power system, in accordance with aspects of inventive concepts. The hot tub hybrid power system can comprise: a connector configured to receive AC power from an external source at a first power level; at least one battery in combination with a DC to AC power transformer configured to output AC voltage at a second power level; and a combiner/regulator configured to selectively output power at the first level, the second level, or a combination of the first and second level based on a state of a hot tub. In various embodiments, a hybrid power source is included within a hot tub system to power all functions and subsystems of the hot tub. In various embodiments, the combiner/regulator facilitates continuous full power supply to all hot tub systems and subsystems from the external source and the battery DC to AC transformer during use or full operation. These subsystems can include, but are not limited to, a heater, a water pump, jets, lights, and so forth. In some embodiments, the hot tub can be powered by standard 120V, with no need for a 240V AC supply. In other embodiments, the hot tub can still run off of a 240V AC supply, but does so more efficiently and allows for the water heater and hydrotherapy jets to be run simultaneously which is not possible today.

In both cases, at least one battery can be added to the power system of the hot tub or spa, e.g., having a rating of between about 1 kwh and 100 kwh (10-15 kwh in some embodiments). The hot tub subsystems, like the heater and pumps, will draw on a combination of (1) the battery and (2) a 120 v outlet to provide “full” capacity of 240 v when the hot tub is in use, which is typically for 10-25% of a given hour during idle times (which are 95% or more of a spa's life), and for 1-2 consecutive hours during times of use. During idle times when no equipment is being used at all, the battery will charge, only to be drawn upon during future times of use, and can charge at off-peak times that are less expensive, to provide cost savings when the battery is drawn on during peak electric rate hours in the evenings. The battery can provide enough extra power to heat the water and run the hydrotherapy jets simultaneously which is not currently possible with traditional hot tub designs using standard residential electrical services. In various embodiments, the battery will be powered by either a 120 v electric input for US purposes. In other regions and/or countries, having different standard power sources, the voltage rating of input AC power and the battery would be adapted accordingly.

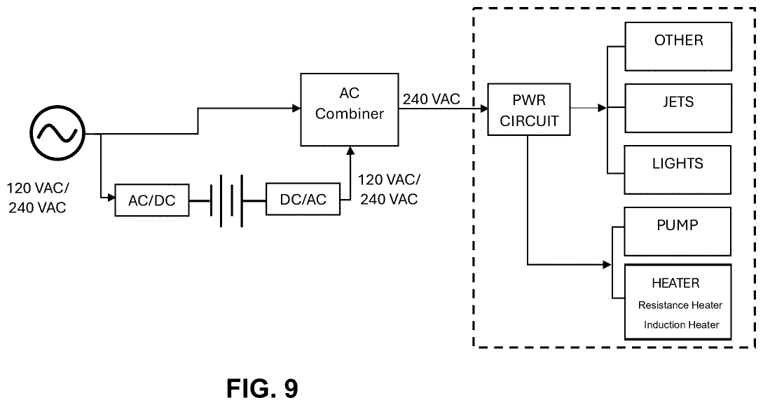

FIG. 9 is a circuit diagram of another embodiment of a hot tub hybrid power system, in accordance with aspects of inventive concepts. In various embodiments, the hybrid power system can include an in-line hybrid battery. For existing hot tubs that run on a 50 a 240 v, indicated within the dashed box in FIG. 9, the hybrid battery concept can be implemented to run on the 20 a 120 v, but the in-line battery could be external to the spa and sit in between the home plug, then the battery hybrid, then the standard 240 v spa plugs into the hybrid battery. Thus, the same hybrid concept could be sold alongside existing and already installs spas, for example. In various embodiments, this approach would “convert” existing spas from 50 a at 240 v to standard household outlet 20 a at 120 v without any modification, just by using an in-line battery solution.

In various embodiments, such as is shown in FIG. 9, the hybrid power system can be configured to be external to the hot tub and used to power existing hot tub systems and subsystems. The external hybrid power system can be retrofitted to fit already existing hot tub applications and allow for hot tubs previously reliant on 240V AC power to only need a 120V power source.

In various embodiments, the voltage combiner/regulator is configured to synchronize a phase of the AC power from the external source with a phase of AC power from the DC to AC power transformer. In various embodiments, the combiner/regulator is configured to determine the power level of the external source and adjust the second power level based on the first power level.

### Induction Heating System

Traditional spa heaters use a resistance heating element with water running past the element to heat the water. These elements operate by converting electric current into heat, which is then transferred to the water. While effective, resistance heating systems can be slow, inefficient, and prone to failure over time due to direct exposure to corrosive water and sanitizing chemicals like chlorine and bromine. Induction heating is a form of heating that utilizes electromagnetic induction to generate heat in electrically conductive materials, which can provide improved efficiency and result in faster heating. Taken on its own, or in conjunction with traditional spa heaters, induction heating can be used to improve overall efficiency of hot tub heating by up to 100%, in accordance with aspects of the inventive concepts.

In the various embodiments discussed herein above, the heater can be a standard electric heater (with resistive element), an induction heater, or a combination that includes the two.

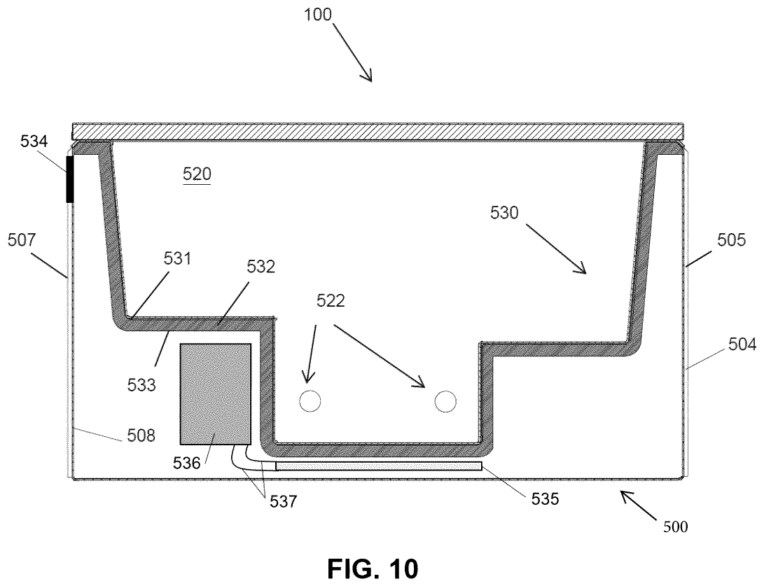

FIG. 10 is a cross-sectional front view of the hot tub lid 100 combined with an embodiment of the hot tub 500, in accordance with aspects of inventive concepts. This view shows the hot tub shell 530 comprising a multiwall vacuum-insulated structure, which includes an inner wall 531, an outer wall 533, and a vacuum insulated layer or material 532 therebetween. Collectively, walls 531 and 533 with vacuum insulating layer 532 therebetween. The embodiment of FIG. 10 further includes an induction coil 535 which receives an alternating current from a power supply 536 through power cables 537 controlled by a control system 534. This forms an embodiment of a multiwall vacuum-insulated structure that utilizes induction heating in accordance with aspects of the inventive concepts.

In this embodiment, the hot tub heating system includes an indication coil 535 positioned adjacent to a conductive hot tub shell 530. In various embodiments, the induction coil is positioned at a base (or bottom) of the hot tub shell between the outer wall 533 and the bottom panel 515 of the cabinet. The shell 530 can be formed from or include a ferromagnetic material that can be heated through electromagnetic induction, including, but not limited to, steel, stainless steel, aluminum, titanium, and iron. The outer wall 533, the inner wall 531, the vacuum insulating layer 532, or any combination herein can be formed from or include a ferromagnetic material. When an alternating current is applied to the induction coil 535 from the control system 534, a magnetic field is generated, inducing eddy currents within the chamber walls, which in turns heat the water inside.

In various embodiments, a control system 534 is configured to regulate the power and frequency of the alternating current that is supplied to the induction coil to control the water temperature. This system provides precise control to ensure the water in the interior volume 520 of the hot tub shell 530 remains at a set temperature. In operation, the user sets a desired temperature using a user interface on the control system 534. The control system 534 activates the induction coil 535 by supplying it with an alternating current. This current generates a magnetic field, which induces eddy currents in the walls of the hot tub shell 530. As the chamber walls heat up, the water circulating through the chamber absorbs the heat, thus increasing the water temperature.

As induction heating can be controlled precisely, continuous monitoring of the water occurs utilizing temperature sensors. If the water temperature approaches a set temperature, the control system 534 can stop the current supply or reduce the current supply to the induction coil 535, to maintain the set water temperature, and reducing overall energy consumption.

In various embodiments, the induction heating can be used in conjunction with the resistance heating elements as shown in the circuit diagrams of FIG. 8 and FIG. 9. The induction heating can be used at times when it would be more efficient as compared to using the resistance heating elements. The resistance heating elements can be used when it would be more efficient compared to the induction heating elements. In various embodiments, the resistance heating elements and the induction heating elements can be used in combination when, for example, the control system indicates it is more efficient that using one heating element over the other.

In various embodiments, the induction heating can be used in conjunction with the resistance heating elements as shown in the circuit diagrams of FIG. 8 and FIG. 9. As example, in some embodiments, the induction heating can be used to heat the floor of the spa, while the resistance heating can be used to heat the water circulated by the jets.

In various embodiments, the induction heating system may include a plurality of induction coils surrounding different sections of the hot tub, including on the circulation piping itself, enabling more uniform heating. In addition, the induction coils could be integrated into the structure of the hot tub, reducing external components and improving the utilization of space, reducing the footprint of the hot tub itself. Because the heating coils are never in direct contact with the hot tub water their lifespan is dramatically longer than a traditional resistance heating system where the heating elements are submersed directly within the water.

While the foregoing has described what are considered to be the best mode and/or other preferred embodiments, it is understood that various modifications can be made therein and that the inventive concepts may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the invention which are, for brevity, described in the context of a single embodiment may also be provided separately or in any suitable sub-combination.

For example, it will be appreciated that all of the features set out in any of the claims (whether independent or dependent) can be combined in any given way.

1.-52. (canceled)

53. A hot tub hybrid power system, comprising:
a connector configured to receive AC power from an external source at a first power level;
at least one battery in combination with a DC to AC power transformer configured to output AC voltage at a second power level; and
a combiner/regulator configured to selectively output power at the first level, the second level, or a combination of the first and second level based on a state of a hot tub.

54. The system of claim 53, wherein the first level and the second power level are substantially the same.

55. The system of claim 53, wherein the first power level is 120 VAC.

56. The system of claim 53, wherein the first power level is 240 VAC.

57. The system of claim 53, wherein the combiner/regulator is configured to synchronize a phase of the AC power from the external source with a phase of AC power from the DC to AC power transformer.

58. The system of claim 53, wherein the combiner/regulator is configured to determine the power level of the external source and adjust the second power level based on the first power level.

59. The system of claim 53, wherein when the external source provides 120 VAC, the combiner/regulator draws 120 VAC from the at least one battery and DC to AC transformer to deliver 240 VAC during a hot tub full operation or use state.

60. The system of claim 53, wherein the at least one battery is configured to charge to full capacity when the hot tub is an idle or nonuse state.

61. The system of claim 53, wherein the battery has a storage capacity between 1 kWh and 100 kWh.

62. The system of claim 61, wherein the storage capacity is between 10 kWh and 15 kWh.

63. The system of claim 53, wherein the combiner/regulator is configured to supply continuous full power supply to a water heater and hydrotherapy jets during simultaneous operation from the external source and a battery DC to AC transformer during use or full operation.

64. The system of claim 53, wherein the combiner/regulator is configured to selectively prioritize drawing power from the battery during peak utility pricing periods.

65. The system of claim 53, wherein the system is modularly configured external to the hot tub for powering pre-existing hot tubs.

66. The system of claim 53, further comprising a heater that includes a heat pump, a gas heater, a propane heater, or an electric heater powered by a 120V or 240V electrical source.

67. The system of claim 53, wherein the hybrid power system is external to a hot tub.

68. The system of claim 67, wherein the combiner is configured to couple with a power cord of the hot tub.

69. The system of claim 53, further comprising a control system configured to monitor the state of the hot tub and regulate power output from the external source and the battery based on operational conditions.

70. The system of claim 69, wherein the control system is configured to prioritize battery power during high energy demand conditions to enable simultaneous operation of a water heater and hydrotherapy jets.

71. The system of claim 53, wherein the hot tub comprises a body having a shell with a multiwall vacuum-insulated structure, and wherein the combiner/regulator is configured to maintain a set water temperature within the shell during periods of low external power availability by prioritizing battery output.

72. The system of claim 53, wherein the hot tub comprises a lid having at least one panel configured for installation onto existing hot tub units, the panel including a multi-wall vacuum-insulated structure formed of at least two anodized aluminum sheet metal walls with a vacuum-insulated volume therebetween, the structure further comprising an anti-corrosion layer.
